(19) United States
(12) Patent Application Publication
(10) Pub. No.: US 2026/0227233 A1
(43) Pub. Date: Aug. 6, 2026

(54) INTERACTIVE SYSTEM AND METHOD FOR PREDICTING ACOUSTIC PROPERTIES OF A WALL

(71) Applicant: UNITED STATES GYPSUM COMPANY, Chicago, IL (US)

(72) Inventors: Lauren Elizabeth MERCER, Chicago, IL (US); Andrew Lee SCHMIDT, Highwood, IL (US); Austin Robert PHILLIPS, Waukegan, IL (US)

(21) Appl. No.: 19/413,776

(22) Filed: Dec. 9, 2025

Related U.S. Application Data
(60) Provisional application No. 63/751,967, filed on Jan. 31, 2025.

(51) Int. Cl. G01H 15/00; G06T 11/60

(52) U.S. Cl. CPC G01H 15/00; G06T 11/60; G06T 2200/24

(57) ABSTRACT

A method generating, in real time, a sound transmission class (STC) and/or a sound transmission loss (STL) for a wall comprises generating a graphical user interface (GUI) for selectively receiving a plurality of input wall parameters for the wall; generating a visual representation of the wall based on received input wall parameters; determining an STC and/or STL based on the wall parameters; and outputting a result. Determining the STC and/or STL includes preprocessing the wall parameters to determine standardized model inputs for a prediction model, and generating the STC and/or STL directly or indirectly using the prediction model.

### REFERENCE TO RELATED APPLICATIONS

This application claims priority to and the benefit of U.S. Provisional Patent Application Ser. No. 63/751,967, filed Jan. 31, 2025, under 35 U.S.C. 119, which application is incorporated by reference in its entirety herein.

### FIELD

The present disclosure relates to processor-assisted architectural design. More specifically, the present disclosure relates to processor-based interactive methods and systems for predicting acoustic properties of a wall based on received parameters.

### BACKGROUND

Currently, building designers (individuals or teams) create or generate building designs based upon experience and current knowledge. However, as the scope of such experience and knowledge can widely vary and decisions based on such experience may be subjective to some degree, resulting building designs may not be optimized but instead may vary significantly, e.g., depending on the designer, as opposed to being based on maximizing efficiency in a more coherent, consistent, or methodical fashion.

For example, parts and sections of a structure that makes up a building may typically be selected based on familiarity and/or common use. As an illustration, while there may be many walls that are available for a building design, an architect may regularly select a wall based simply upon familiarity with the design and its common use, and not, say, because it would maximize floor space or because the components of the wall or the least expensive or readily available in the area of the country in which the building is to be built.

However, such methods have to date been insufficient.

### SUMMARY

Embodiments provide, among other things, a method of generating, in real time, a sound transmission class (STC) for a wall using a processor and memory, the method comprising: generating, on a user display, a graphical user interface (GUI) for selectively receiving a plurality of input wall parameters for the wall; receiving the input wall parameters; generating, on the user display, a visual representation of the wall based on the received input wall parameters; receiving a confirmation of the visual representation; in response to the confirmation, determining an STC based on the wall parameters; and outputting a result based on the determined STC on the display; wherein said determining the STC comprises: preprocessing the wall parameters to determine a set of standardized model inputs for a sound transmission loss (STL) prediction model, inputting the determined set of standardized model inputs into the STL prediction model; predicting one or more sound transmission losses using the STL prediction model; and determining the STC from the predicted one or more sound transmission losses.

Additional embodiments provide a system for generating a sound transmission class (STC) and/or a sound transmission loss (STL) for a wall in real time, comprising: a processor; a memory; a display generator implemented by the processor and memory for causing to be generated on a display: a graphical user interface (GUI) for selectively receiving a plurality of input wall parameters for the wall from a user; a visual representation of the wall based on received input wall parameters; and an output result based on a determined STC and/or STL; and a determination module implemented by the processor and memory for determining the STC and/or STL based on the wall parameters in response to a received confirmation of the visual representation; wherein said determination module comprises: a prediction model for predicting one or more sound transmission losses and/or sound transmission classes based on an input set of standardized model inputs; and a preprocessor for preprocessing the received input wall parameters to determine the set of standardized model inputs for the prediction model.

Other embodiments provide a method of generating, in real time, a sound transmission class (STC) for a wall using a processor and memory, the method comprising: generating, on a user display, a graphical user interface (GUI) for selectively receiving a plurality of input wall parameters for the wall; receiving the input wall parameters; generating, on the user display, a visual representation of the wall based on the received input wall parameters; receiving a confirmation of the visual representation; in response to the confirmation, determining an STC based on the wall parameters; and outputting a result based on the determined STC on the display; wherein said determining the STC comprises: preprocessing the wall parameters to determine a set of standardized model inputs for an STC prediction model, inputting the determined set of standardized model inputs into the STC prediction model; and determining the STC using the STC prediction model.

Other embodiments provide a method of generating, in real time, a sound transmission loss (STL) for a wall using a processor and memory, the method comprising: generating, on a user display, a graphical user interface (GUI) for selectively receiving a plurality of input wall parameters for the wall; receiving the input wall parameters; generating, on the user display, a visual representation of the wall based on the received input wall parameters; receiving a confirmation of the visual representation; in response to the confirmation, determining one or more sound transmission loss (STL) values based on the wall parameters; and outputting a result based on the determined one or more sound transmission loss (STL) values on the display; wherein said determining the one or more sound transmission loss (STL) values comprises: preprocessing the wall parameters to determine a set of standardized model inputs for an STL prediction model, inputting the determined set of standardized model inputs into the STL prediction model; and determining the one or more sound transmission loss (STL) values using the STL prediction model.

Other embodiments provide an apparatus for optimizing a building layout comprising: a processor; a memory; and machine-executable instructions stored in the memory for causing the processor to perform one or more methods as provided herein.

Other features and advantages of the invention will be apparent from the following specification taken in conjunction with the following figures.

### BRIEF DESCRIPTION OF THE DRAWINGS

The present disclosure will become more fully understood from the detailed description and the accompanying figure, wherein:

FIG. 1 shows an example computer-implemented system for generating a Sound Transmission Class (STC) and/or one or more Sound Transmission Losses (STLs), according to an example embodiment.

FIG. 2 shows an example method for generating and displaying an STC and/or an STL.

FIG. 3 shows an example method for visual wall generation.

FIG. 4 shows an example preprocessing method for wall parameters.

FIG. 5 shows an example STC/STL prediction method.

FIG. 6 shows an example postprocessing method for prediction results.

FIGS. 7A-7B show data flow in an example STC/STL generation method.

FIG. 8 shows an example GUI for receiving input wall parameters.

FIG. 9 shows an example GUI output including a visual representation of a wall and a numerical output based on an example prediction result.

FIG. 10 shows an example GUI output including a graph based on an example prediction result, including predicted sound transmission loss (STL) over various frequency bands and depicting a reference line.

FIG. 11A shows an example operation for a GUI generation module.

FIG. 11B shows an example operation for an example wall builder module.

FIG. 11C shows an example preprocessing operation.

FIG. 11D shows an example prediction model operation.

FIG. 11E shows an example postprocessing and graphing operation.

FIGS. 11F-11G show an example GUI flow.

FIG. 12 shows an environment in which example systems and methods may be implemented.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

### Example System

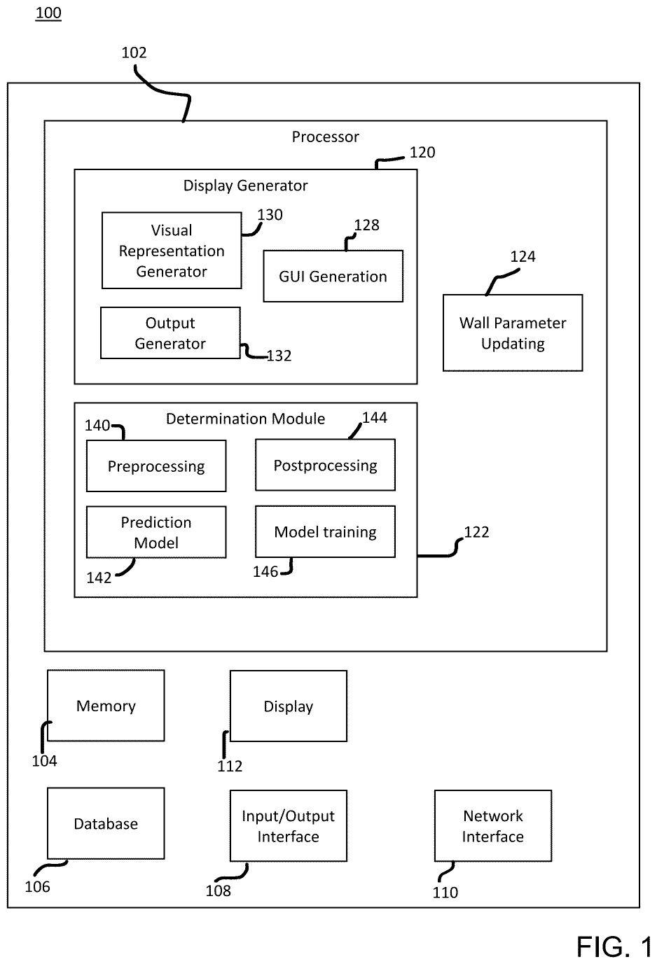

Turning now to the drawings, FIG. 1 shows an example system 100 for generating one or more sound transmission classes (STCs) and/or one or more sound transmission losses (STLs) according to an example embodiment. The system 100 includes a processor 102 (which may include one or more processors), a memory 104 (which may include one or more memory units) in communication with the processor, and a storage (which may include one or more storage units) such as a database 106 in communication with the memory for storing, e.g., instructions, parameters, results, inputs, etc. The system 100 may also include input and output interfaces 108, e.g., user interfaces, network interface(s) 110, e.g., for local and/or remote communication, and one or more displays 112, which may be directly or indirectly coupled, at any location, for displaying results and/or for user operation. The system 100 may be implemented via one or more computing devices, e.g., connected computing devices.

The example processor 102 can execute machine-readable instructions, e.g., stored in the memory 104 and optionally provided via the storage 106, to implement various components of the system 100 for performing example methods. For instance, the processor 102 can implement a display generator 120, a Sound Transmission Class (STC) and/or Sound Transmission Loss (STL) determination module (determination module) 122, and, optionally, a wall parameter updating module 124. The machine-readable instructions may be provided in any suitable language, a nonlimiting example of which being Python, e.g., with one or more libraries.

The display generator 120 includes a GUI generation module 128 for generating a graphical user interface (GUI), a visual representation generator 130, and an output generator 132. An example GUI may be provided, as a nonlimiting example, using a GUI toolkit such as TTK. The GUI generation module 128 can be configured to selectively receive from a user one or more, e.g., a plurality, of input wall parameters for a wall via the display 112 and the input/output interface 118, and may perform other interface operations. Input wall parameters may be used alone or in combination with one or more default wall parameters for example operations.

The visual representation generator 130 can be configured to generate on the display 112 a visual representation of the wall based on (directly or indirectly) the received input wall parameters and may perform other visual generation operations. The visual representation may be, but need not be, interactive and/or editable by a user, e.g., via the display 112 and input/output interface 108.

The output generator 132 can be configured to generate on the display 112 one or more output results based on one or more determined STCs and/or STLs. The wall parameter updater 124 may be configured for updating initial and/or default wall parameters based on the received input wall parameters, in response to other received inputs by a user, e.g., received for editing the generated visual representation, or by other operations (e.g., feasibility checks). The updated wall parameters, including the received input, may be used (directly or indirectly) by the visual representation generator 130 to update the generated visual representation.

The determination module 122 is configured to determine one or more STCs and/or STLs based on the wall parameters. This determination may be, e.g., in response to a received confirmation (e.g., from the user or from other sources) of the visual representation generated by the visual representation generator 130. The determination module 122 includes a preprocessing module 140 for preprocessing received input wall parameters to determine, directly or indirectly, a set of standardized model inputs for a prediction model 142, which may be embodied in or include a sound transmission loss (STL) prediction model and/or a sound transmission class (STC) prediction model. Both models or either model may be used for the example prediction model. An example prediction model is embodied in one or more machine learning (ML) models. A postprocessing module 144 may be provided for processing predicted values from the prediction model 142 to provide one or more results that may be output, for instance, via output generator 132. Example results may include, but are not limited to, STC results. The prediction model 142 may alternatively or additionally be embodied in an STC prediction model for predicting STLs and/or STCs directly.

An example prediction model is a machine learning model (ML), a nonlimiting example being a linear forest model, though other models are possible. Models may be combined in any suitable manner to perform example operations herein. A model training module 146 may be provided for training the prediction model 142. The prediction model 142 may be trained, for instance, using datasets that include sets of prior standardized model inputs, which may or may not correspond to sets of prior wall parameters.

### Example Operation

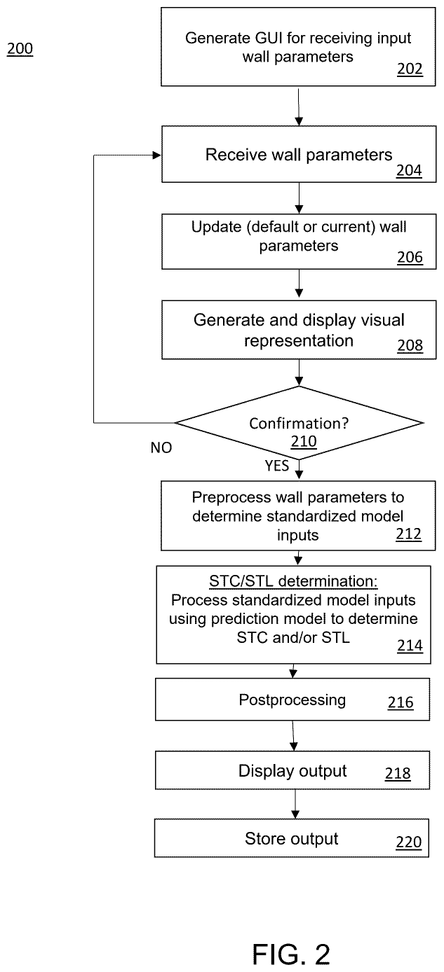

Referring now to FIG. 2, an example method 200 that may be performed by the system 100, e.g., by the configured processor 102, will now be described. The method 200 may be performed in real-time (e.g., during an interaction with a user). The GUI generation module 128 generates at 202 a GUI for selectively receiving one or more wall parameters for a wall that are input, e.g., by a user. Example GUI features may include, as nonlimiting examples, dropdown boxes, combo boxes, free input (e.g., form fields or other input fields), radio buttons, etc. Other example GUIs for receiving wall parameters are disclosed herein, and still others are possible.

Example input wall parameters can include, for instance, a number of boards, one or more board parameters, one or more framing system parameters for a frame, parameters for an insulation material, parameters for a resilient channel material, or any combination. Example board parameters may include, for instance, a board sheathing type for board layers on sides of the wall, e.g., at least one board layer on each side. Example framing system (frame) parameters include, for instance, material type, depth, spacing, and/or gauge. Example insulation material parameters include, for instance, presence or absence of insulation (as insulation may be optional), insulation type, and/or insulation thickness. Example resilient channel parameters include, for instance, presence or absence of resilient channel material (as a resilient channel may be optional), resilient channel type, and/or thickness.

Wall parameters can vary, e.g. in type, format, number, units, etc. Different wall parameters may be needed for different example methods. Input wall parameters may provide, update, and/or supplement existing (e.g., stored or retrievable), current, or default wall parameters.

The wall parameters are received at 204, and the wall parameters updating module 124 may update one or more default, prepopulated, or current wall parameters (e.g., revise, add to, replace) at 206 using the received wall parameters, either directly or indirectly. As nonlimiting examples, an input wall parameter for a selected board type may replace a default or a previous board type, or an input frame depth may be used to replace or recalculate an existing frame system parameter.

The visual representation generator 130 can generate and display (directly on the display 112 or cause to be displayed on another display) a visual representation of a wall at 208 based on the input wall parameters, alone or in combination with other wall parameters (e.g., default or current wall parameters). This visual representation may be interactive and/or editable by a user, but need not be in all methods. The user may review the generated wall and either confirm that the wall and/or wall parameters are acceptable at 210, or may provide further wall parameters at 204, e.g., by editing the displayed wall via the GUI, by directly entering one or more updated or additional wall parameters, or in other ways. If new wall parameters are received at 204, the wall parameters may again be updated at 206, and a new visual representation of the wall can be generated at 208. The visual representation may be produced using any suitable method, a nonlimiting example being a Pixel-based drawing widget.

If the wall and/or wall parameters are confirmed at 210, e.g., by receiving a prompt, an execute input, a command, etc., in any suitable manner, the determination module 122 can in response determine one or more STCs and/or STLs based on the wall parameters. For instance, the preprocessing module 140 can preprocess the wall parameters at 212 to determine (e.g., a set of) standardized model inputs for the (e.g., trained) prediction model 142. The standardized model inputs are input to the prediction model, and the prediction model processes at 214 the standardized model inputs to predict one or more STCs and/or STLs. An example prediction model, for instance, may predict one or more predicted STLs within one or more frequency bands or ranges, e.g., a one-third octave band. Another example prediction model may predict STC directly, e.g., as a single-number output without an intermediate STL determination.

The postprocessing module 144 can process at 216 the predicted STCs and/or STLs in any suitable manner to provide any of various results. Example postprocessing operations are described in further detail herein. The output generator module 132 can generate at 218 an output for displaying on the display 112 the result or any portion thereof based on the determined STL and/or STC. Example results and associated displays are provided herein. Results may additionally or alternatively be stored at 220, e.g., in the memory 104 and/or storage 106.

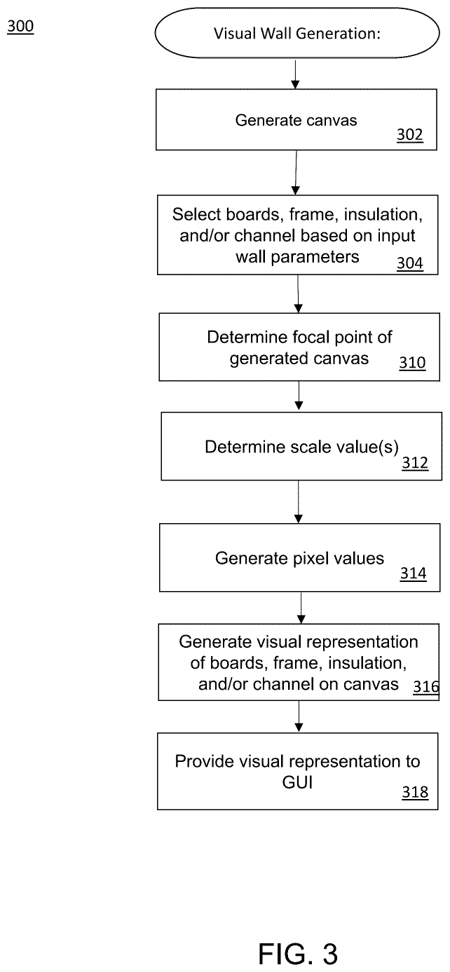

FIG. 3 shows an example visual wall generation method 300 that may be performed by the visual representation generator 130. The visual representation may be two-dimensional (2D), three-dimensional (3D), or a combination (e.g., a 3D representation with selectable 2D views). Reference to 2D generation methods herein will be appreciated to likewise be applicable to 3D generation methods.

A canvas is generated at 302, e.g., that is defined by a 2D grid. A prior canvas, e.g., from a previously generated visualized wall, may be cleared before generating step 302. One or more wall components, e.g., boards, insulation, frame, and/or channel, configured by size, type, material, etc., are selected at 304 based on the input wall parameters. These input wall parameters may be originally input wall parameters or updated wall parameters from a user review of an earlier visualized wall. Other wall parameters, e.g., prior or default wall parameters, may be used with the input wall parameters for selecting at 304.

The visual representation generator 130 then generates the visual representation of the wall with selected wall components. In the example method 300, a focal point of the generated canvas is determined, e.g., calculated and/or retrieved (such as but not limited to using one or more lookup tables), at 310. As a nonlimiting example, the focal point may be a geometric center of the canvas, though other focal points are possible. One or more scale values are determined, e.g., calculated and/or retrieved, at 312 for the selected boards, frame, insulation, and/or resilient channel. Pixel values are generated at 314, e.g., calculated and/or retrieved, for the selected boards, frame, insulation, and/or resilient channel based on the located focal point and the generated scale value. The generated pixel values may then be used to generate the visual representation of the selected boards, frame, insulation, and/or resilient channel on the canvas at 316. The generated visual representation of the wall may be provided at 318 to the GUI generation module 128 for incorporating the visual representation into the displayed GUI, as shown by example herein.

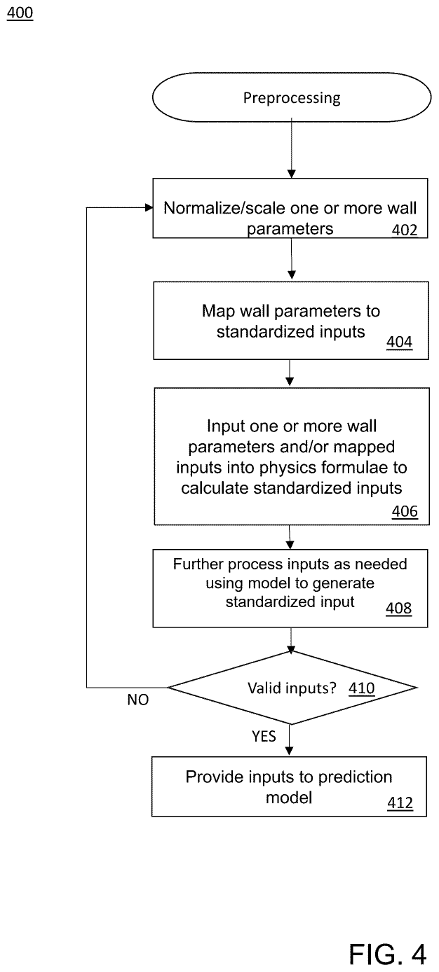

FIG. 4 shows an example preprocessing method 400 that may be performed by the preprocessing module 140 for providing standardized model inputs for the prediction model 142 from the input wall parameters (supplemented as needed by other parameters such as default parameters). Standardized model inputs can include model inputs that are suitable for being provided to the trained prediction model, e.g., model inputs corresponding to inputs from one or more datasets used to train the prediction model. The input wall parameters or other parameters and the standardized model inputs may be provided from respectively different fields or domains. The number, type, format, and/or configuration of example standardized inputs can vary based on the prediction model 142 that is used. As a nonlimiting example, the standardized model inputs may include or be embodied in one or more strings, Boolean fields, floating fields, or others.

The example preprocessing method 400 may perform one or more processing operations, including any suitable combination of operations, to convert or transform the wall parameters to provide the standardized model inputs. Accordingly, the example steps and order shown in FIG. 4 is only an example, and individual steps may be performed and/or repeated in any order to arrive at the standardized model inputs. For instance, one or more of the wall parameters may be normalized and/or scaled at 402. One or more wall parameters may be mapped to standardized inputs and/or intermediate values at 404, e.g., by determining one or more standardized inputs, intermediate values or parameters, or other values using a lookup table based on the wall parameters. For instance, a lookup table may relate one or more wall parameters to one or more values.

Alternatively or additionally, one or more wall parameters, or intermediate values or parameters (e.g., from mapping step 404) may be input into one or more formulae to calculate one or more standardized inputs. Nonlimiting example calculations include physics calculations such as acoustic and/or structural calculations. Results of such calculations can be further processed at 408 using additional mapping, calculation, or other example operations. Example formulae, STC values, STL values, and/or other parameters may be retrieved from one or more databases.

The determined standardized inputs may be evaluated at 410 for validity, e.g., for one or more of feasibility, internal consistency, compliance with required model inputs for the prediction model 142, consistency with the input user wall parameters, or other criteria. If the inputs are determined to be valid, they can be provided as inputs to the prediction model at 412. Otherwise, the determined standardized inputs may be updated or revised, e.g., by repeating one or more of the example converting or transforming operations 402, 404, 406, 408.

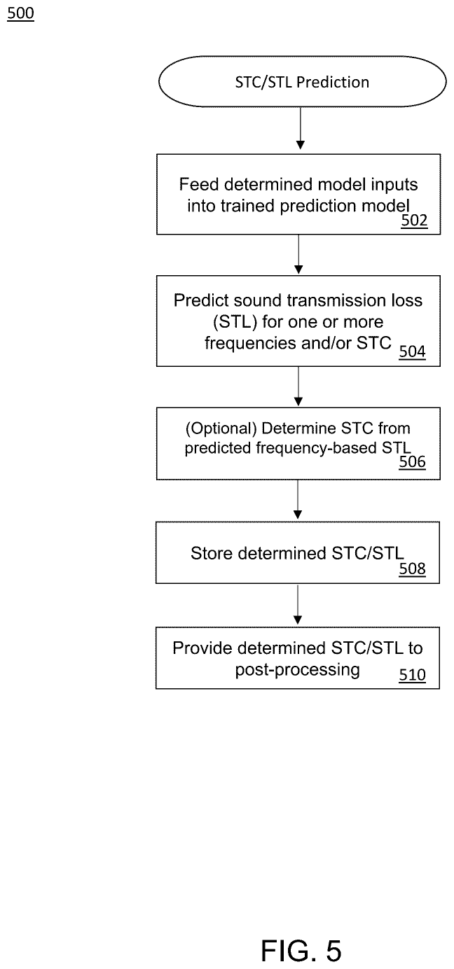

FIG. 5 shows an example method 500 for predicting STC and/or STL. The determined (standardized) model inputs are input or fed at 502 into the trained prediction model 142, e.g., a trained STL prediction model or trained STC prediction model. The prediction model 142 processes the model inputs and predicts one or more sound transmission losses (STLs) for one or more frequencies and/or one or more STCs. As a non-limiting example, the prediction model 142 may predict one or more, e.g., multiple, STLs across frequencies within bands such as one-third octave bands. As another example, the prediction model 142 may predict an STC directly. The predicted STLs and/or STCs may be provided as one or more values and/or the predicted STLs may be provided as one or more STL curves with (e.g., predicted) high and low confidence bounds. An example confidence interval is a 95% confidence interval, though this can be higher or lower.

A sound transmission class or STC may be determined at 504, e.g., by being predicted from the prediction model 142 directly and/or by further processing STLs at 506 that are predicted by the prediction model at 504, e.g., for one or more frequency bands (e.g., one-third octave bands). For instance, a reference line may be provided or determined for the predicted STLs across the band of frequencies, and the STC may be calculated from the STLs and the reference line. The determined STC and/or STLs may be embodied in, for instance, one or more STL values, one or more STC values, one or more confidence intervals for STL or STC, in any suitable format or unit. The determined STC(s) and/or STL(s) may be stored at 508, e.g., in memory 104 or storage 106, and may be provided at 510 to the postprocessing module 144 for one or more postprocessing operations.

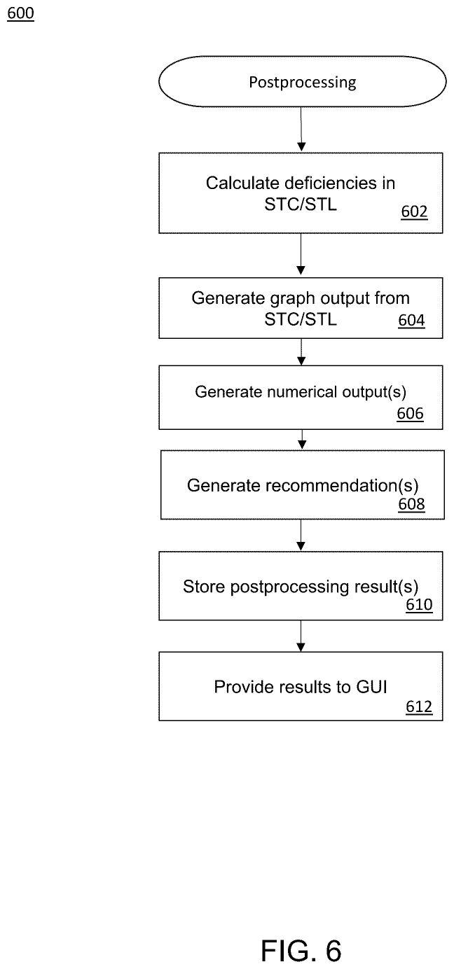

FIG. 6 shows an example postprocessing method 600, which may include one or more postprocessing steps, in any combination, using the determined STC or STL results. Postprocessing may be omitted in other methods. In the example postprocessing 600, deficiencies, if any, are calculated in the STC (or the STL) at 602 using one or more formulae, comparisons, or other operations. If a deficiency is found, the deficiency may be corrected or ignored, and/or one or more preprocessing or prediction operations such as in methods 400, 500 may be performed to provide a new STC or STL prediction or determination.

A graph output may be provided at 604 from the determined STC or STL results. Example graphs are provided herein, but others are possible. If a reference line was used to determine the STC, for instance, a graph depicting STC results and/or STL results may be generated that depicts the reference line. The graph may include one or more indications, e.g., legends, labels, colors, etc., to indicate items such as frequencies, high confidence, low confidence, thresholds, etc. Additionally or alternatively, one or more numerical outputs may be generated at 606 from the determined STC and/or STL, including single or multiple numerical outputs, e.g., values, confidence intervals, ranges, etc. Any suitable downstream processing, including default processing, processing requested by a user, etc., may be performed on the determined STC and/or STL results to provide an output. Example numerical outputs are provided herein, but others are possible. The determined STC and/or STL, alone or in addition to one or more postprocessing results, can be further used to generate one or more recommendations at 608, such as materials or parts orders, budget estimates, installation guides, comparisons, etc. Any or all postprocessing results can be stored at 610, e.g., in memory 104 or storage 106, and/or may be provided at 612 to the GUI generation module 128 for displaying a result.

### Example Information Flow

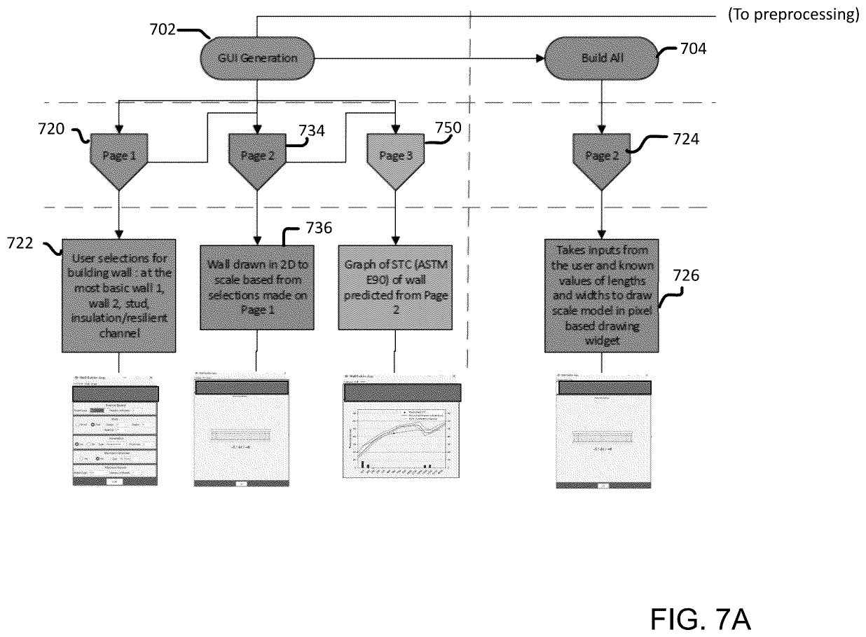

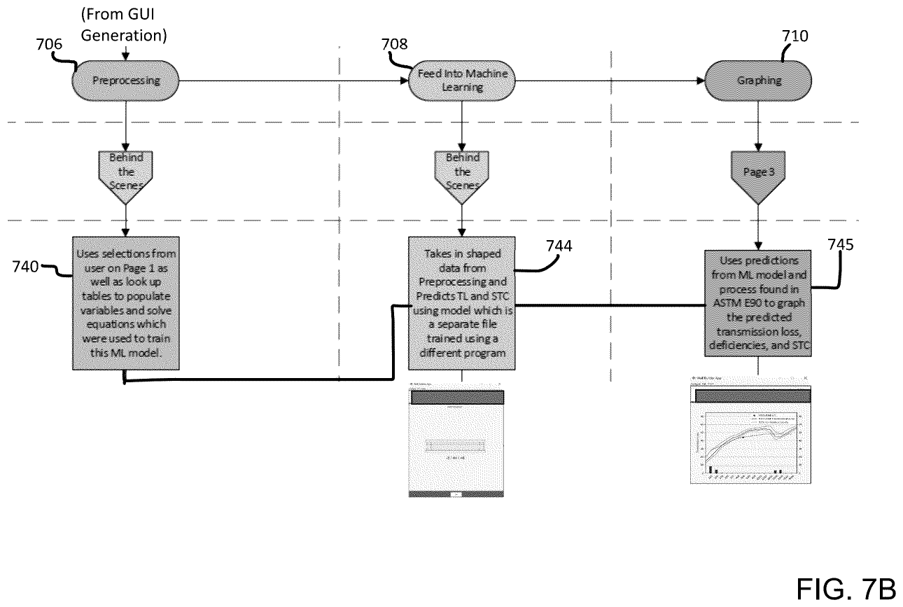

FIGS. 7A-7B show an example information flow among an example GUI generation module 702 (an example of GUI generation module 128), a builder module 704 (an example of visual representation generator 130), a preprocessing module 706 (an example of preprocessing module 140), a prediction module 708 (an example of prediction module 142), and a graphing module 710 (an example of postprocessing module 144 and output generator 132).

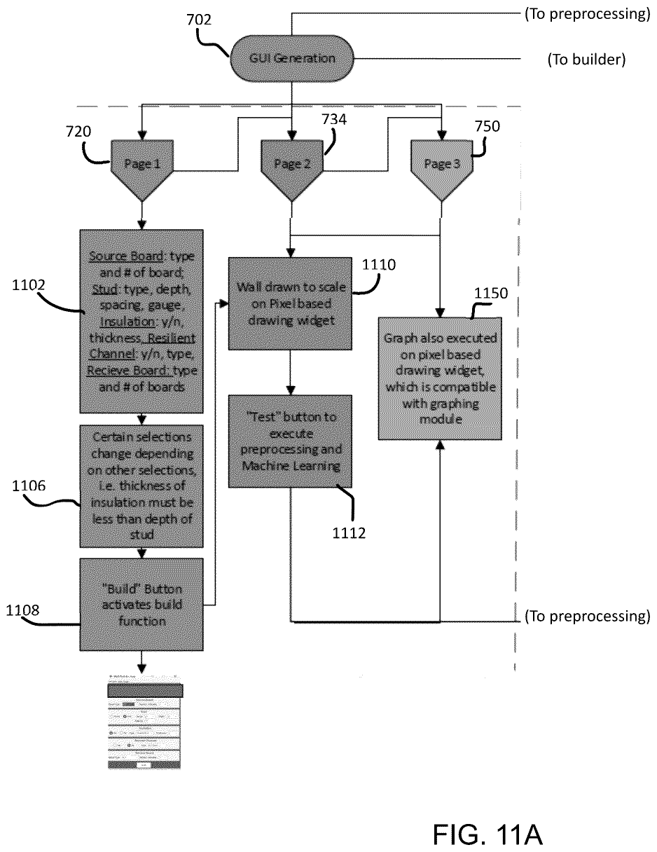

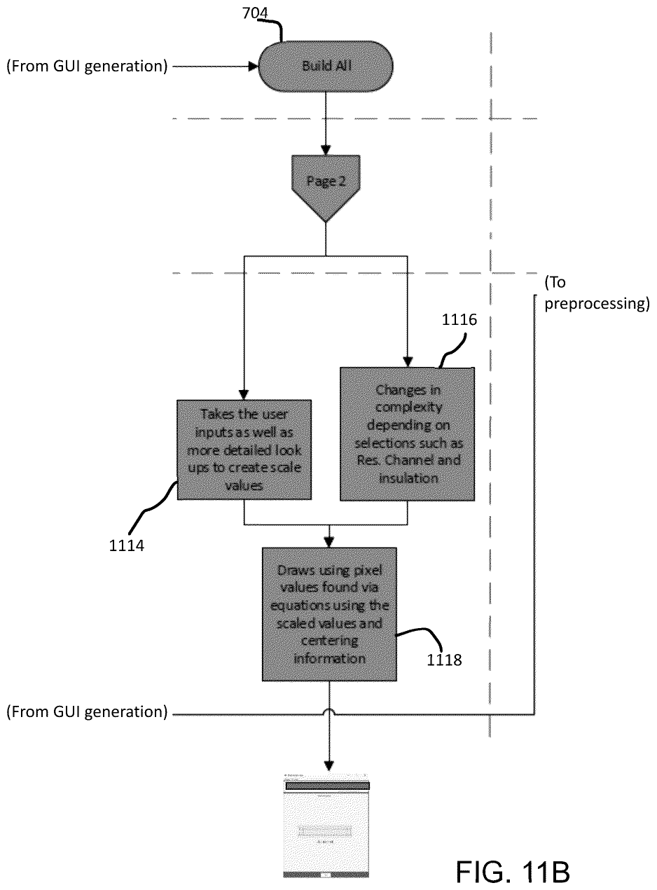

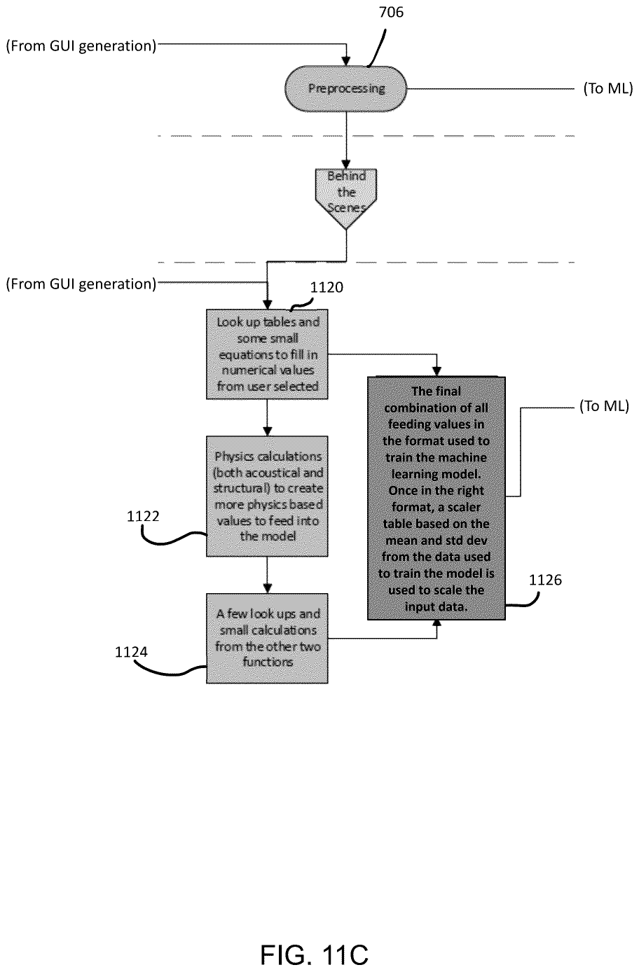

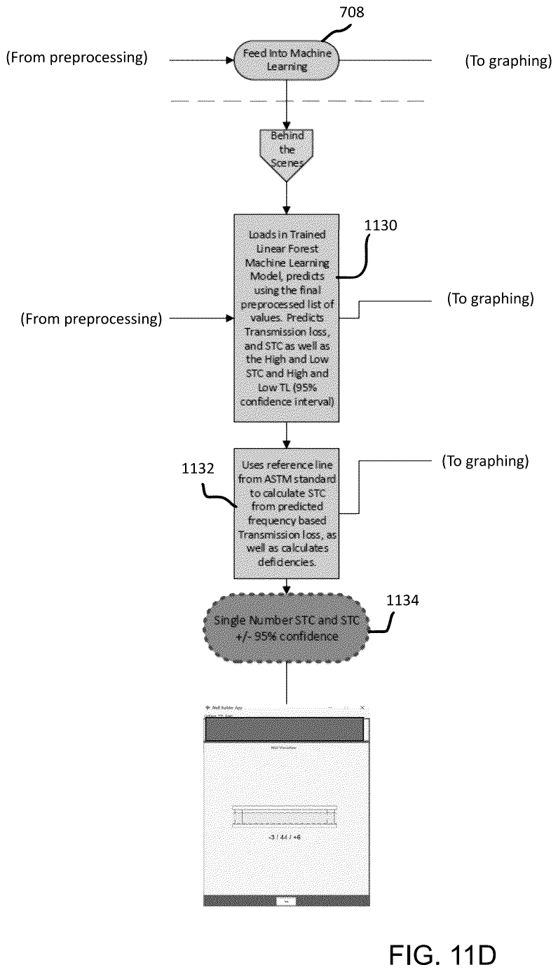

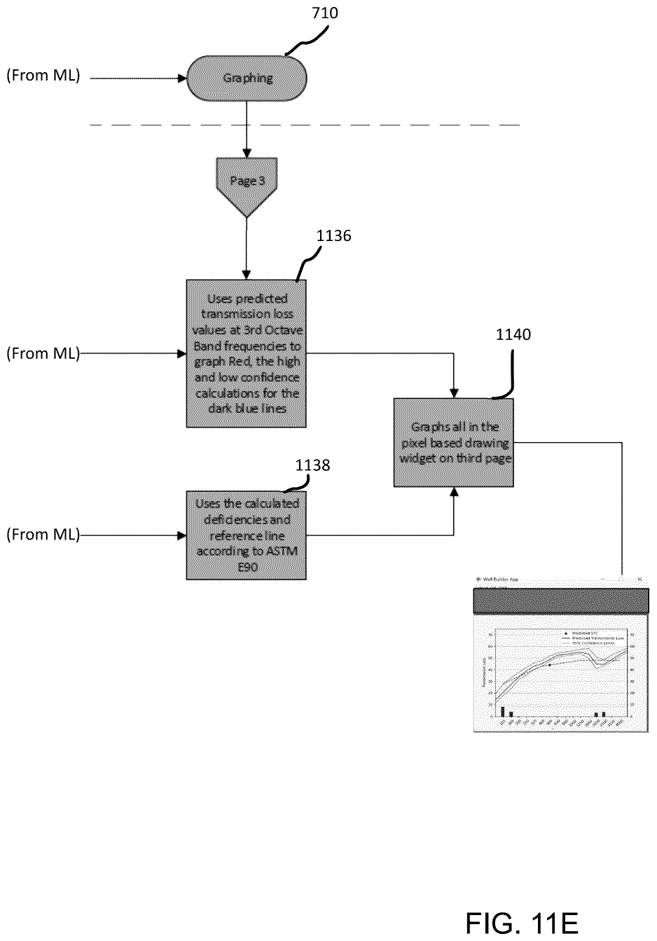

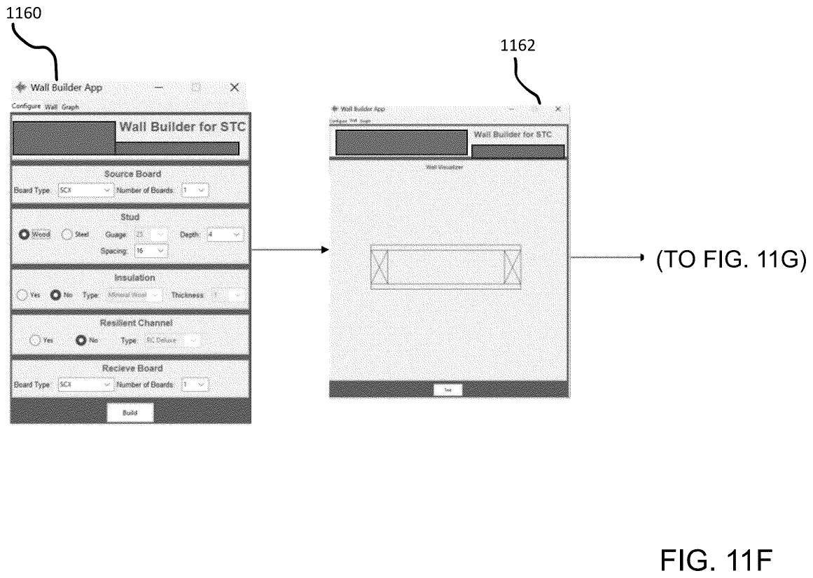

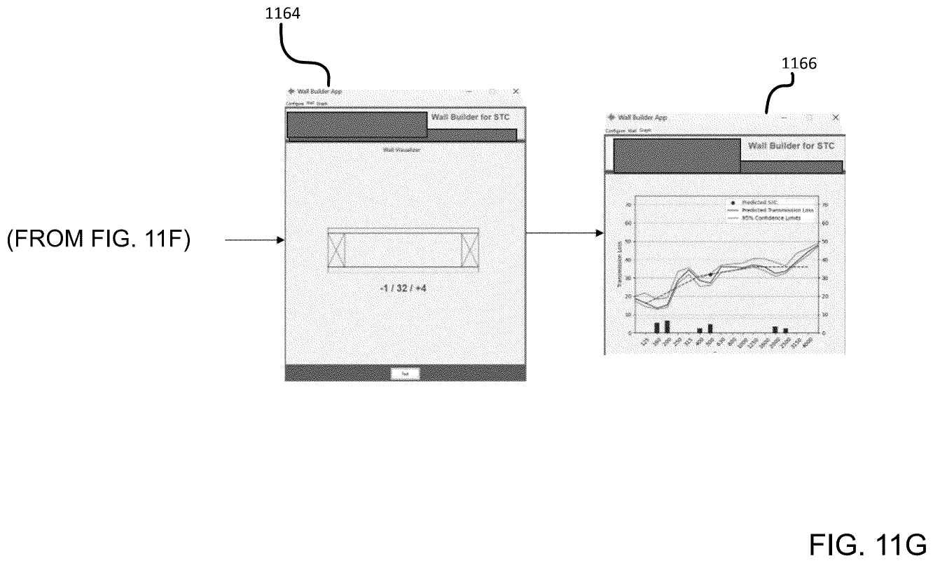

For a first page of a GUI (Page 1) 720, the GUI generation module 702 receives 722, for a basic wall, wall parameters for wall, stud, insulation, and resilient channel. FIG. 11A shows example steps that may be performed for step 722. Selections for input wall parameters are displayed at 1102, including, for a source board: source board type and number of boards; for a stud: stud type, gauge, spacing, and depth; for insulation: presence or absence (y/n), and type; for resilient channel: presence or absence (y/n), and type; and, for receive board: board type and number of boards. As shown at 1106, one or more selections may be updated in the GUI depending on previous selections. For example, the thickness of the insulation should be less than the depth of the stud, so the available thickness and/or depth selections may be updated to reflect this. An activation interface, e.g., a “Build” function, is provided for the GUI at 1108 to initiate a wall visualization building operation.

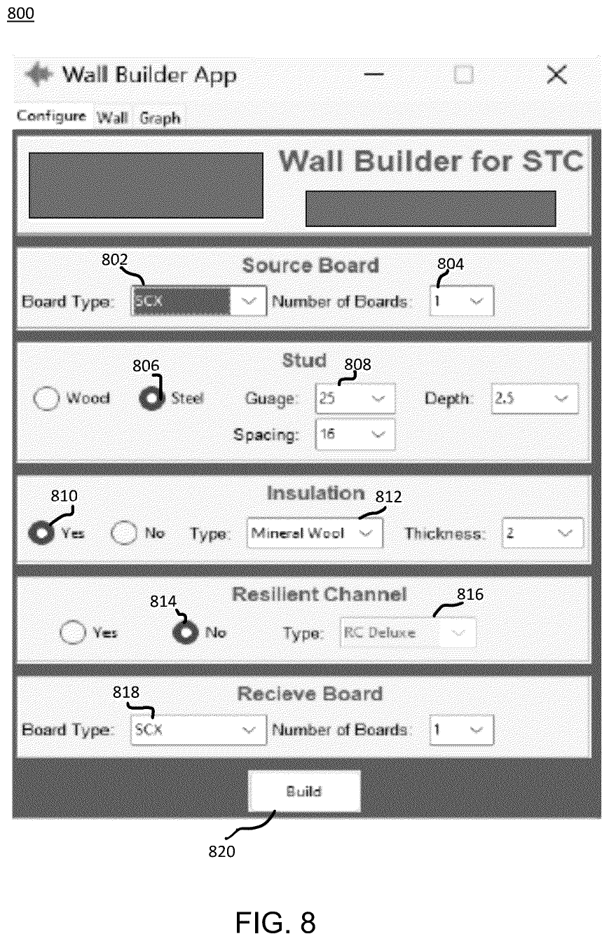

FIG. 8 shows an example GUI page 800 corresponding to Page 1. The page 800 includes, for a source board: dropdowns 802 for a source board type and for a number of boards 804; for a stud: radio selection 806 for selecting either wood or steel and dropdowns 808 for gauge, spacing, and depth; for insulation: radio selection 810 for presence or absence, and dropdowns 812 for type and thickness; for resilient channel: radio selection 814 for presence or absence, and dropdowns 816 for type; and, for receive board: dropdowns 818 for board type and number of boards. The selections may be prepopulated or provided with a default choice. A confirmation input, e.g., a “Build” button 820, is provided to request that a visualized wall be built.

The builder module 704 generates an additional page (Page 2) 724 of the GUI in response to the user's activation of the “Build” button 820. The builder module 704 can generate a graph at 726 by receiving wall parameter inputs from the user via the Page 1 interface and then providing any other inputs needed, e.g., (e.g., default inputs, retrieved inputs, etc. if any). For instance, the builder module 704 may retrieve known values of lengths and widths of selected wall components corresponding to the input wall parameters. These values are processed to generate a scale model, e.g., in a pixel-based drawing widget, of a proposed wall including the selected wall components on a 2D canvas, e.g., arranged with respect to a focal point.

FIG. 11B shows example steps for graph generation 726. The builder module 704 may use at 1114 the user provided wall parameters in addition to one or more additional parameters, e.g., retrieved via a lookup table or other source, if needed. If wall parameters for additional, optional features such as insulation or a resilient channel are input, the builder module 704 can incorporate these into the graph at 1116. The builder module 704 then may determine pixel values, e.g., via one or more equations based on determined scale, focal point (e.g., center), and wall component sizes, etc., and draw at 1118, e.g., using pixel values, a graph of the proposed wall using the scaled values and centering information.

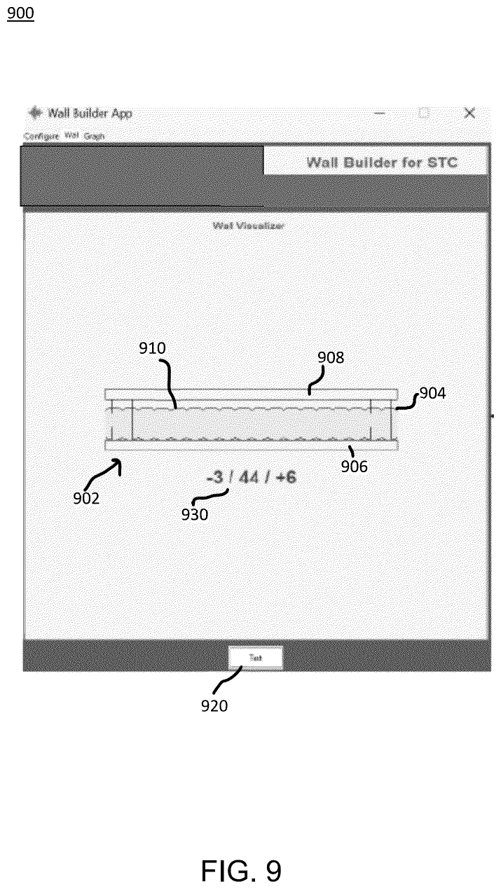

For an example GUI page 734 corresponding to Page 2, the GUI generation module 702 then generates a visualization, e.g., draws, a 2D wall to scale 736 from the generated scale model. FIG. 9 shows an example GUI Page 2 900 corresponding to Page 2 (734). Referring again to FIG. 11A, in an example of graph drawing 736, the wall may be drawn to scale at 1110 using a pixel-based drawing widget to incorporate into the GUI. A user confirmation is provided at 1112 for the GUI at Page 2, e.g., a “Test” button, and in response to the user confirmation, executing preprocessing and prediction are performed.

Page 2, illustrated in FIG. 9, includes a visualization 900 of a wall 902 including a frame 904 (e.g., studs), a receive board 906, a source board 908, and mineral wool insulation 910. A resilient channel is not shown, as it was not selected in Page 1. A user confirmation, e.g., a “Test” button 920, is provided for allowing a user to confirm the wall and commence an example STC and/or STL generation. If the user wishes to change any of the wall parameters after viewing the proposed wall at Page 2, the user may navigate to Page 1 to enter updated wall parameters and request that a new wall visualization be generated.

In response to the user confirmation, e.g., activation of the “Test” button 920, the preprocessing module 706 receives the selected user parameters from Page 1. The preprocessing module 706 then performs preprocessing at 740 to determine, e.g., populate (or finish populating) or shape the standardized model inputs, such as retrieving model inputs from lookup tables, calculating standardized model inputs using one or more formulae or equations, etc. One or more of the selected user parameters may also be used directly as part of the standardized model inputs in some example methods.

FIG. 11C shows example steps for the preprocessing 740. The preprocessing module 706 may use at 1120 retrieved data, e.g., lookup tables, and/or one or more calculations from (e.g., small) equations to further populate numerical values from the input user parameters. Physics calculations, e.g., acoustical, structural, etc., may be used at 1122 to calculate one or more physics-based values. Additional data retrieval, e.g., table lookup, and/or small calculations may be performed at 1124 from the results of steps 1120 and/or 1122. The results from any of steps 1120, 1122, or 1124, in addition to any user parameters that are not converted, any default inputs, etc., are combined at 1126 to provide the model inputs. These model inputs, for instance, may be standardized in that they are entirely or substantially in the format of the inputs used to train the prediction model. Values may be normalized or scaled. For example, once in the correct format, a scaler, e.g., a table, that may be based on the mean and standard deviation from data used to train the model can be used to scale the model inputs.

The determined standardized inputs are then provided to the prediction model 142, e.g., prediction model 708. The prediction model 142 receives the preprocessed (e.g., shaped) data and predicts Sound Transmission Loss (STL) and/or Sound Transmission Class (STC) at 744. The prediction model may be, e.g., a separate file that may be externally trained, e.g., offline.

FIG. 11D shows steps in an example prediction 744. The determined model inputs from the preprocessing, e.g., the most recent preprocessed combination or list of values, are loaded into the prediction model 142, e.g., a trained linear forest machine learning model, at 1130 as standardized model inputs. The prediction model 142 may process the standardized model inputs to predict one or more of sound transmission loss (STL) for one or more frequencies, e.g., frequencies within one or more frequency bands, sound transmission class (STC), upper and lower STCs within a confidence interval (e.g., 95%), and/or upper and lower STLs within a confidence interval (e.g., 95%). A reference line, e.g., from ASTM or other standards, may be used at 1132 to calculate STC from the predicted frequency-based STL, and may also calculate one or more deficiencies.

An example result of the prediction 744, e.g., a single-number STC numerical value and STC within a confidence interval range as shown in FIG. 11D or other prediction result, may be provided at 1134 to the GUI generation module 702. An example result is shown as an output 930 for including with the visualized wall 902 for the example Page 2 in FIG. 9. Example results from steps 1130 and 1132 may additionally or alternatively be provided to the graphing module 710.

For generating a graph output, the graphing module 710 uses predictions from the prediction model 142, along with any additional data needed (which may be generated, retrieved, etc.) to graph one or more of the predicted STL, deficiencies, and/or STC at 744. An example of additional data for generating the graph may be a reference line provided from one or more testing standards (a nonlimiting example being ASTM E90) or other sources that will be appreciated by an artisan. FIG. 11E shows example operations for the graphing 744. With the results provided from step 1130, for instance, the graphing module 710 can use predicted STL values at, e.g., frequencies in one or more bands (as a nonlimiting example, one-third octave bands) to graph high and low confidence calculations at 1136. With the results provided from step 1132, the graphing module 710 can use calculated deficiencies and/or a reference line (e.g., as determined from testing standards) at 1138. The results from steps 1136 and 1138 may then be used to generate a graph, e.g., using a pixel-based drawing widget.

The generated graph can be provided to the GUI generation module 702 for displaying the graph in the GUI, e.g., at a Page 3 (750). For instance, as shown in step 1150 of FIG. 11A, the graph may also be executed on a pixel-based drawing widget that can be compatible with the graphing module used to generate the graph for Page 2.

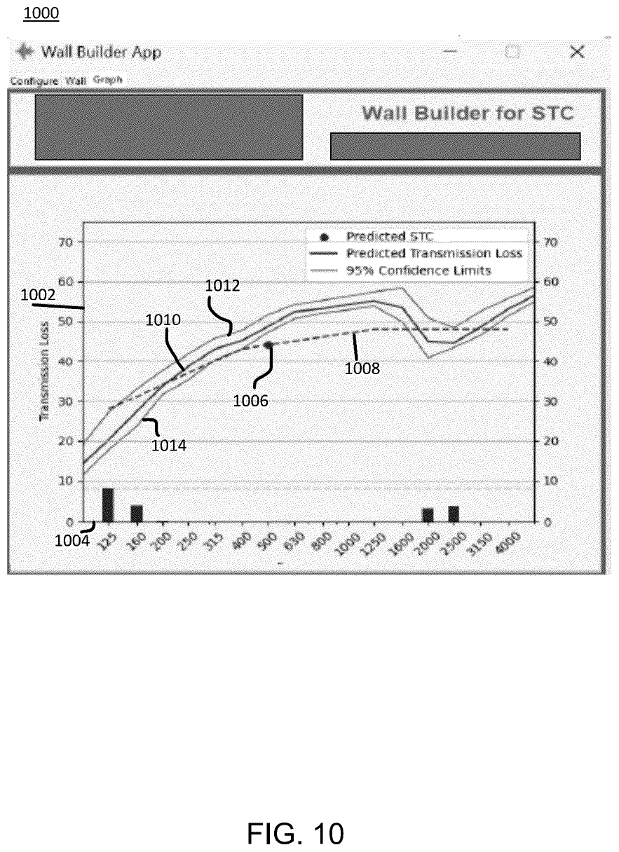

FIG. 10 shows an example graph 1000 displayed on Page 3 of the GUI. The graph 1000 includes axes 1002, 1004 for sound transmission loss and frequencies, respectively, a predicted STC 1006, a reference line 1008, and generated curves for predicted sound transmission loss 1010 and upper and lower 95% confidence limits 1012, 1014.

FIGS. 11F-11G show another example STL/STC determination and GUI flow incorporating example features, including additional examples for Pages 1, 2, and 3 provided above. In the example Page 1 (1160), the user selects a board type (SCX) for the source, and receive boards, a wood stud with spacing of 16 and a depth of 4 (gauge 25 is provided as a default based on the selection of the stud), and no insulation or resilient channel. Based on the selected board type, the example system may retrieve, e.g., via a lookup table, a variable board thickness. Upon receiving a user selection to build a wall visualization via the “Build” button, the retrieved board thickness and number of boards are provided for the wall builder 704, which determines a location of a pixel relative to a focal point (e.g., center) of a 2D canvas for placing board pixels. Similarly, the location of pixels for the studs are determined, and Page 2 (1162) is generated.

The user parameters, including board thickness, resilient channel thickness (no resilient channel is selected in this example) and stud thickness are also entered into a calculation for total wall thickness. These and all (for instance) other variables are scaled, e.g., using a SciKit Standard Scaler that is trained using the same dataset used to train the example prediction model (e.g., linear forest model). In response to the user selecting the “Test” button on Page 2, the scaled variables are used by the prediction model to predict an STC, e.g., 32, as well as a “high predicted STC” (+4, or 36) and a “low predicted STC” (−1, or 31). An updated page 2 (1164) is shown including these results, where the +/− number are determined via subtracting the average predicted STC (here, 32) from these numbers.

Additionally, the STL numbers in this example are predicted directly using the prediction model (e.g., linear forest model) and the above scaled variables. The results are provided in a graph on Page 3 (1166). The high and low values are also predicted and graphed, in this example using a function that takes in a quantile value (0.05, 0.95), the testing matrix, and the model to transpose the predicted high and low STL values. In this example, two trained machine learning models may be used, one whose output provides a single number STC and another whose output provides STL values over frequency.

### Network Architecture

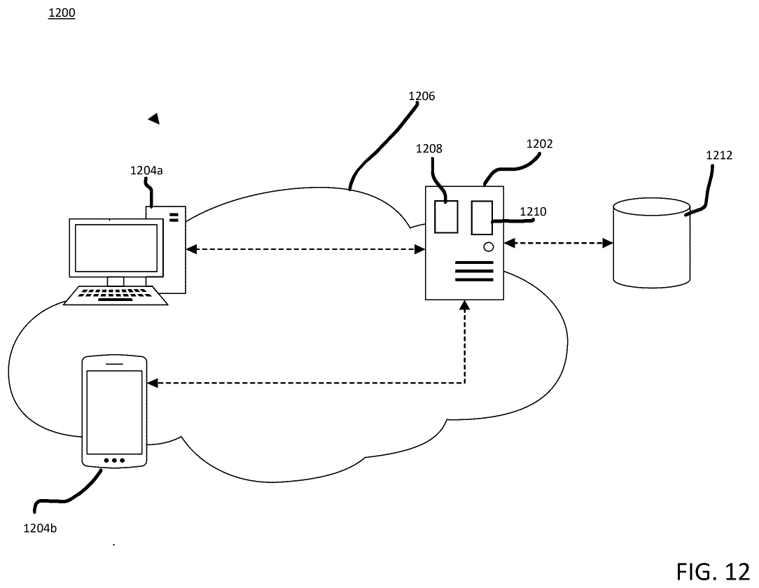

Example systems, methods, and embodiments may be implemented within a network architecture 1200 such as illustrated in FIG. 12, which comprises a server 1202 and one or more client devices 1204 that communicate over a network 1206 which may be wireless and/or wired, or local or wide area, such as but not limited to the Internet, for data exchange. The server 1202 and the client devices 1204a, 1204b can each include a processor, e.g., processor 1208 and a memory, e.g., memory 1210 (shown by example in server 1202), such as but not limited to random-access memory (RAM), read-only memory (ROM), hard disks, solid state disks, or other non-volatile storage media. Memory 1210 may also be provided in whole or in part by external storage in communication with the processor 1208.

The system 100 may be embodied in the server 1202 and/or one or more client devices 1204. It will be appreciated that the processor 1208 can include either a single processor or multiple processors operating in series or in parallel, and that the memory 1210 can include one or more memories, including combinations of memory types and/or locations. Server 1202 may also include, but are not limited to, dedicated servers, cloud-based servers, or a combination (e.g., shared). Storage, e.g., a database, may be embodied in suitable storage in the server 1202, client device 1204, a connected remote storage 1212 (shown in connection with the server 1202, but can likewise be connected to client devices), or any combination.

Client devices 1204 may be any processor-based device, terminal, etc., and/or may be embodied in a client application executable by a processor-based device, etc. Client devices may be disposed within the server 1202 and/or external to the server (local or remote, or any combination) and in communication with the server. Example client devices 1204 include, but are not limited to, computers 1204a, or mobile communication devices (e.g., smartphones, tablet computers, etc.) 1204b, and others. Client devices 1204 may be configured for sending data to and/or receiving data from the server 1202, and may include, but need not include, one or more output devices, such as but not limited to displays, printers, etc. for displaying or printing results of certain methods that are provided for display by the server. Client devices may include combinations of client devices.

In an example training method, the server 1202 or client devices 1204 may receive a dataset from any suitable source, e.g., from memory 1210 (as nonlimiting examples, internal storage, an internal database, etc.), from external (e.g., remote) storage 1212 connected locally, or over the network 1206. The example training method can generate a trained model that can be likewise stored in the server (e.g., memory 1210), client devices 1204, external storage 1212, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example interactive STL or STC generation method (e.g., at runtime) the server 1202 may receive inputs from any suitable source, e.g., by local or remote input from a suitable interface, or from another of the server or client devices connected locally or over the network 1206. The example system 100 can be likewise stored in the server (e.g., memory 1210), external storage 1212, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

The invention is further illustrated by the following example embodiments. However, the invention is not limited to the following embodiments.
1. A method of generating, in real time, a sound transmission class (STC) for a wall using a processor and memory, the method comprising: generating, on a user display, a graphical user interface (GUI) for selectively receiving a plurality of input wall parameters for the wall; receiving the input wall parameters; generating, on the user display, a visual representation of the wall based on the received input wall parameters; receiving a confirmation of the visual representation; in response to the confirmation, determining an STC based on the wall parameters; and outputting a result based on the determined STC on the display; wherein said determining the STC comprises: preprocessing the wall parameters to determine a set of standardized model inputs for a sound transmission loss (STL) prediction model, inputting the determined set of standardized model inputs into the STL prediction model; predicting one or more sound transmission losses using the STL prediction model; and determining the STC from the predicted one or more sound transmission losses.
2. The method of Embodiment 1, wherein the GUI is a multi-input user interface.
3. The method of any one or more of Embodiments 1-2, wherein the input wall parameters comprise: a number of boards; and/or one or more board parameters; and/or one or more framing system parameters for a frame comprising at least one stud; and/or an insulation material; and/or a resilient channel material.
4. The method of any one or more of Embodiments 1-3, wherein the board parameters comprise a board sheathing type for at least one board layer on each side of the wall.
5. The method of any one or more of Embodiments 1-4, wherein the framing system parameters comprise: a material type; and/or a depth; and/or a spacing; and/or a gauge.
6. The method of any one or more of Embodiments 1-5, wherein the insulation material parameters comprise: presence or absence of insulation; and/or an insulation type; and/or an insulation material thickness.
7. The method of any one or more of Embodiments 1-6, wherein the resilient channel material parameters comprise: presence or absence of insulation; and/or a resilient channel type; and/or a resilient channel thickness.
8. The method of any one or more of Embodiments 1-7, further comprising: displaying one or more default or prepopulated input wall parameters.
9. The method of any one or more of Embodiments 1-8, wherein the displayed one or more default or prepopulated input wall parameters are configurable by the user via the GUI.
10. The method of any one or more of Embodiments 1-9, wherein the GUI comprises one or more of: dropdown boxes; combo boxes; free inputs; or radio buttons.
11. The method of any one or more of Embodiments 1-10, further comprising: receiving initial wall parameters; and updating the provided set of selectable wall parameters based on the received initial wall parameters.
12. The method of any one or more of Embodiments 1-11, further comprising: updating initial wall parameters based on received input wall parameters.
13. The method of any one or more of Embodiments 1-12, further comprising receiving a prompt, and wherein said generating the visual representation occurs in response to the received prompt.
14. The method of any one or more of Embodiments 1-13, wherein the prompt comprises an execute or command input.
15. The method of any one or more of Embodiments 1-14, wherein the visual representation is editable by the user via the GUI.
16. The method of any one or more of Embodiments 1-15, wherein the visual representation is interactive.
17. The method of any one or more of Embodiments 1-16, wherein the visual representation is drawn using a Pixel-based drawing widget.
18. The method of any one or more of Embodiments 1-17, wherein the visual representation comprises a visual representation of: one or more boards; and/or insulation, if any; and/or a resilient channel, if any.
19. The method of any one or more of Embodiments 1-18, wherein the visual representation is scaled.
20. The method of any one or more of Embodiments 1-19, wherein the visual representation is two-dimensional or three-dimensional.
21. The method of any one or more of Embodiments 1-20, wherein said generating the visual representation comprises: generating a canvas, the canvas being definable by a two-dimensional grid; selecting boards, a frame, optionally insulation, and optionally a resilient channel for the wall based on the input wall parameters; and generating a visual representation of the selected boards, frame, and optionally the insulation and/or the resilient channel on the generated canvas.
22. The method of any one or more of Embodiments 1-21, wherein said generating the visual representation further comprises: determining a focal point of the generated canvas; generating one or more scale values for the selected boards, frame, insulation, and/or resilient channel; generating pixel values based on the located focal point, and the generated scale values; and generating a visual representation of the boards, frame, insulation, and/or resilient channel on the canvas using the generated pixel values.
23. The method of any one or more of Embodiments 1-22, wherein said generating one or more scale values comprises using one or more lookup tables.
24. The method of any one or more of Embodiments 1-23, wherein the focal point is a geometric center of the generated canvas.
25. The method of any one or more of Embodiments 1-24, wherein said generating the visual representation further comprises clearing a prior canvas.
26. The method of any one or more of Embodiments 1-25, wherein the confirmation comprises a command to determine the STC that is received via the GUI.
27. The method of any one or more of Embodiments 1-26, further comprising: receiving one or more inputs for editing the generated visual representation; updating the wall parameters based on the received one or more inputs; and updating the visual representation on the display.
28. The method of any one or more of Embodiments 1-27, wherein the STL prediction model comprises a machine learning model that is trained to predict an STL.
29. The method of any one or more of Embodiments 1-28, wherein the machine learning model is trained using datasets comprising prior wall parameters.
30. The method of any one or more of Embodiments 1-29, wherein the machine learning model comprises a linear forest model.
31. The method of any one or more of Embodiments 1-30, wherein the machine learning model is coded in Python.
32. The method of any one or more of Embodiments 1-31, wherein the wall parameters and the standardized model inputs comprise respectively different fields or domains.
33. The method of any one or more of Embodiments 1-32, wherein said preprocessing maps one or more of the wall parameters to the standardized model inputs.
34. The method of any one or more of Embodiments 1-33, wherein said preprocessing transforms one or more of the wall parameters to the standardized model inputs using one or more calculations.
35. The method of any one or more of Embodiments 1-34, wherein the standardized model inputs comprise one or more of: strings; Boolean fields; or floating fields.
36. The method of any one or more of Embodiments 1-35, wherein the standardized model inputs are normalized or scaled.
37. The method of any one or more of Embodiments 1-36, wherein said preprocessing the wall parameters comprises determining one or more indirect or direct parameters using a lookup table based on the wall parameters to determine standardized model inputs.
38. The method of any one or more of Embodiments 1-37, wherein said preprocessing the wall parameters comprises performing one or more calculations using the wall parameters and/or the indirect parameters to determine standardized model inputs.
39. The method of any one or more of Embodiments 1-38, wherein the one or more calculations comprise physics calculations.
40. The method of any one or more of Embodiments 1-39, wherein the physics calculations comprise acoustical and/or structural calculations.
41. The method of any one or more of Embodiments 1-40, wherein the at least one predicted STL comprises one or more predicted STLs for multiple one-third octave bands.
42. The method of any one or more of Embodiments 1-41, further comprising: generating a confidence interval for the at least one predicted STL.
43. The method of any one or more of Embodiments 1-42, wherein said determining an STC further comprises: scaling or normalizing the determined standardized model inputs.
44. The method of any one or more of Embodiments 1-43, further comprising: predicting, by the machine learning model, one or more predicted STL values for one or more frequencies; and calculating the STC from the one or more predicted frequency based STL values.
45. The method of any one or more of Embodiments 1-44, wherein the one or more predicted STL values comprises a predicted STL curve with predicted high and low confidence bounds.
46. The method of any one or more of Embodiments 1-45, wherein said calculating the STC from the one or more predicted frequency based STL values uses a reference line.
47. The method of any one or more of Embodiments 1-46, further comprising: calculating one or more deficiencies in the STC.
48. The method of any one or more of Embodiments 1-47, wherein the output result comprises a graph.
49. The method of any one or more of Embodiments 1-48, wherein the graph is labeled or colored to indicate one or more of frequencies, high confidence, or low confidence.
50. The method of any one or more of Embodiments 1-49, wherein said calculating an STC from the predicted one or more sound transmission losses uses a reference line, and wherein the graph further comprises a depiction of the reference line.
51. The method of any one or more of Embodiments 1-50, wherein the output result comprises one or more numerical outputs.
52. The method of any one or more of Embodiments 1-51, wherein the numerical outputs comprise one or more of: an STL value; and/or a single number STC; and/or a confidence interval for STL.
53. A system for generating a sound transmission class (STC) and/or a sound transmission loss (STL) for a wall in real time, comprising: a processor; a memory; a display generator implemented by the processor and memory for causing to be generated on a display: a graphical user interface (GUI) for selectively receiving a plurality of input wall parameters for the wall from a user; a visual representation of the wall based on the received input wall parameters; and an output result based on a determined STC and/or STL; and a determination module implemented by the processor and memory for determining the STC and/or STL based on the wall parameters in response to a received confirmation of the visual representation; wherein said determination module comprises: a prediction model for predicting one or more sound transmission losses and/or sound transmission classes based on an input set of standardized model inputs; and a preprocessor for preprocessing the received input wall parameters to determine the set of standardized model inputs for the prediction model.
54. The system of Embodiment 53, wherein the input wall parameters comprise one or more of: a number of boards; and/or one or more board parameters; and/or one or more framing system parameters for a frame comprising at least one stud; and/or an insulation material; and/or a resilient channel material.
55. The system of any one or more of Embodiments 53-54, wherein the display generator further causes to be displayed one or more default or prepopulated input wall parameters via the GUI.
56. The system of any one or more of Embodiments 53-55, further comprising: a wall parameter updater for updating initial or default wall parameters based on the received input wall parameters.
57. The system of any one or more of Embodiments 53-56, wherein the display generator comprises: a visual representation generator for generating the visual representation of the wall based on the received input wall parameters.
58. The system of any one or more of Embodiments 53-57, wherein the visual representation is interactive and/or editable by a user.
59. The system of any one or more of Embodiments 53-58, wherein the visual representation generator is configured to: generate a canvas, the canvas being definable by a two-dimensional grid; select boards and insulation for the wall based on the input wall parameters; and generate a visual representation of the selected boards, frame, insulation, and/or insulation channel on the generated canvas.
60. The system of any one or more of Embodiments 53-59, wherein the visual representation generator is further configured to: determine a focal point of the generated canvas; generate one or more scale values for the selected boards, frame, insulation, and/or insulation channel; generate pixel values based on the located focal point, and the generated scale values; and generate the visual representation of the boards, frame, insulation, and/or insulation channel on the canvas using the generated pixel values.
61. The system of any one or more of Embodiments 53-60, further comprising: a wall parameter updater for updating initial or default wall parameters based on the received input wall parameters and/or based on one or more received inputs for editing the generated visual representation; wherein the visual representation generator is further configured to update a generated visual representation based on the one or more received inputs.
62. The system of any one or more of Embodiments 53-61, wherein the predictor model comprises at least one trained machine learning model, the at least one trained machine learning model being trained to predict one or more STL and/or STC values.
63. The system of any one or more of Embodiments 53-62, wherein the at least one trained machine learning model comprises a linear forest model.
64. The system of any one or more of Embodiments 53-63, wherein said preprocessor maps one or more of the wall parameters to the standardized model inputs, and/or transforms one or more of the wall parameters to the standardized model inputs using one or more calculations.
65. The system of any one or more of Embodiments 53-64, wherein the predictor model scales and/or normalizes the standardized model inputs.
66. The system of any one or more of Embodiments 53-65, wherein the one or more calculations comprise physics calculations, the physics calculations comprising acoustical and/or structural calculations.
67. The system of any one or more of Embodiments 53-66, wherein the predictor model is further configured to generate a predicted STL curve with predicted high and low confidence bounds.
68. The system of any one or more of Embodiments 53-67, further comprising: an STC determining module configured to: calculate the STC from a predicted frequency based STL.
69. The system of any one or more of Embodiments 53-68, wherein the output result comprises a graph; wherein the graph comprises one or more of:
   indicators for indicating predicted STL values for one or more frequencies; and/or a reference line used for calculating the STC from the predicted STL values.
70. The system of any one or more of Embodiments 53-69, wherein the output result comprises one or more numerical outputs; wherein the numerical outputs comprise one or more of: an STL value; and/or a single number STC; and/or a confidence interval for STL.
71. A method of generating, in real time, a sound transmission class (STC) for a wall using a processor and memory, the method comprising: generating, on a user display, a graphical user interface (GUI) for selectively receiving a plurality of input wall parameters for the wall; receiving the input wall parameters; generating, on the user display, a visual representation of the wall based on the received input wall parameters; receiving a confirmation of the visual representation; in response to the confirmation, determining an STC based on the wall parameters; and outputting a result based on the determined STC on the display; wherein said determining the STC comprises: preprocessing the wall parameters to determine a set of standardized model inputs for an STC prediction model, inputting the determined set of standardized model inputs into the STC prediction model; and determining the STC using the STC prediction model, alone or in combination with any one or more of Embodiments 1-52.
72. A method of generating, in real time, a sound transmission loss (STL) for a wall using a processor and memory, the method comprising: generating, on a user display, a graphical user interface (GUI) for selectively receiving a plurality of input wall parameters for the wall; receiving the input wall parameters; generating, on the user display, a visual representation of the wall based on the received input wall parameters; receiving a confirmation of the visual representation; in response to the confirmation, determining one or more sound transmission loss (STL) values based on the wall parameters; and outputting a result based on the determined one or more sound transmission loss (STL) values on the display; wherein said determining the one or more sound transmission loss (STL) values comprises: preprocessing the wall parameters to determine a set of standardized model inputs for an STL prediction model, inputting the determined set of standardized model inputs into the STL prediction model; and determining the one or more sound transmission loss (STL) values using the STL prediction model, alone or in combination with any one or more of Embodiments 1-52.

Other embodiments provide an apparatus for optimizing a building layout comprising: a processor; a memory; and machine-executable instructions stored in the memory for causing the processor to perform a method according to any one or more of Embodiments 1-52.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. It will be readily understood that the aspects of the present disclosure, as generally described herein, and illustrated in the figures, can be arranged, substituted, combined, separated, and designed in a wide variety of different configurations, all of which are explicitly contemplated herein. In other words, the described embodiments are not mutually exclusive, and permutations of one or more embodiments with one another remain within the scope of this disclosure. Other embodiments may be utilized, and other changes may be made, without departing from the scope of the subject matter presented herein.

Any of the above aspects and embodiments can be combined with any other aspect or embodiment as disclosed here in the Summary, Figures and/or Detailed Description sections, except where such combinations would be infeasible as will be appreciated by an artisan.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

As used in this specification and the claims, the singular forms “a,” “an” and “the” include plural referents unless the context clearly dictates otherwise.

Unless specifically stated or obvious from context, as used herein, the term “or” is understood to be inclusive and covers both “or” and “and.”

Unless specifically stated or obvious from context, as used herein, the term “about” is understood as within a range of normal tolerance in the art, for example within 2 standard deviations of the mean. About can be understood as within 20%, 19%, 18%, 17%, 16%, 15%, 14%, 13%, 12%, 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of,” or “majority of” encompass at least about 90%, 95%, 97%, 98%, 99% or 99.5%, or more of a referenced amount of a composition.

References to “a processor” or “processor,” “memory,” or “storage” herein are intended to likewise refer to one or more processors, one or more memories or memory elements, or one or more storage devices, respectively, which may be directly or indirectly connected to one another in any suitable manner, whether wired or wireless, and whether directly or over one or more networks.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. A method of generating, in real time, a sound transmission class (STC) for a wall using a processor and memory, the method comprising:
generating, on a user display, a graphical user interface (GUI) for selectively receiving a plurality of input wall parameters for the wall;
receiving the input wall parameters;
generating, on the user display, a visual representation of the wall based on the received input wall parameters;
receiving a confirmation of the visual representation;
in response to the confirmation, determining an STC based on the wall parameters; and
outputting a result based on the determined STC on the display;
wherein said determining the STC comprises:
preprocessing the wall parameters to determine a set of standardized model inputs for a sound transmission loss (STL) prediction model,
inputting the determined set of standardized model inputs into the STL prediction model;
predicting one or more sound transmission losses using the STL prediction model; and
determining the STC from the predicted one or more sound transmission losses.

2. The method of claim 1, wherein the input wall parameters comprise:
a number of boards; and/or
one or more board parameters; and/or
one or more framing system parameters for a frame comprising at least one stud; and/or
an insulation material; and/or
a resilient channel material.

3. The method of claim 2, wherein the board parameters comprise a board sheathing type for at least one board layer on each side of the wall.

4. The method of claim 2, wherein the framing system parameters comprise:
a material type; and/or
a depth; and/or
a spacing; and/or
a gauge;
wherein the insulation material parameters comprise:
presence or absence of insulation; and/or
an insulation type; and/or
an insulation material thickness; and
wherein the resilient channel material parameters comprise:
presence or absence of insulation; and/or
a resilient channel type; and/or
a resilient channel thickness.

5. The method of claim 1, further comprising:
displaying one or more default or prepopulated input wall parameters, wherein the displayed one or more default or prepopulated input wall parameters are configurable by the user via the GUI;
further comprising:
receiving initial wall parameters; and
updating the provided set of selectable wall parameters based on the received initial wall parameters;
wherein the visual representation is editable by the user via the GUI; and
wherein the confirmation comprises a command to determine the STC that is received via the GUI.

6. The method of claim 1, wherein said generating the visual representation comprises:
generating a canvas, the canvas being definable by a two-dimensional grid;
selecting boards, a frame, optionally insulation, and optionally a resilient channel for the wall based on the input wall parameters; and
generating a visual representation of the selected boards, frame, and optionally the insulation and/or the resilient channel on the generated canvas.

7. The method of claim 6, wherein said generating the visual representation further comprises:
determining a focal point of the generated canvas;
generating one or more scale values for the selected boards, frame, insulation, and/or resilient channel;
generating pixel values based on the located focal point, and the generated scale values; and
generating a visual representation of the boards, frame, insulation, and/or resilient channel on the canvas using the generated pixel values.

8. The method of claim 1, wherein the STL prediction model comprises a machine learning model that is trained to predict an STL.

9. The method of claim 1, wherein the wall parameters and the standardized model inputs comprise respectively different fields or domains.

10. The method of claim 1, wherein said preprocessing comprises one or more of:
mapping one or more of the wall parameters to the standardized model inputs; or
transforming one or more of the wall parameters to the standardized model inputs using one or more calculations.

11. The method of claim 1, wherein the standardized model inputs comprise one or more of:
strings;
boolean fields; or
floating fields;
wherein the standardized model inputs are normalized or scaled.

12. The method of claim 1, wherein said preprocessing the wall parameters comprises one or more of:
determining one or more indirect or direct parameters using a lookup table based on the wall parameters to determine standardized model inputs; and
preprocessing the wall parameters by performing one or more calculations using the wall parameters and/or the indirect parameters to determine standardized model inputs;
wherein the one or more calculations comprise acoustical and/or structural calculations.

13. The method of claim 1, further comprising:
generating a confidence interval for the at least one predicted STL.

14. The method of claim 1, wherein said determining an STC further comprises:
scaling or normalizing the determined standardized model inputs.

15. The method of claim 1, further comprising:
predicting, by the machine learning model, one or more predicted STL values for one or more frequencies; and
calculating the STC from the one or more predicted frequency based STL values.

16. The method of claim 1, wherein the output result comprises a graph;
wherein the graph is labeled or colored to indicate one or more of frequencies, high confidence, or low confidence;
wherein said calculating an STC from the predicted one or more sound transmission losses uses a reference line, and wherein the graph further comprises a depiction of the reference line.

17. The method of claim 1, wherein the output result comprises one or more numerical outputs;
wherein the numerical outputs comprise one or more of:
an STL value; and/or
a single number STC; and/or
a confidence interval for STL.

18. A system for generating a sound transmission class (STC) and/or a sound transmission loss (STL) for a wall in real time, the system comprising:
a processor;
a memory;
a display generator implemented by the processor and memory for causing to be generated on a display:
a graphical user interface (GUI) for selectively receiving a plurality of input wall parameters for the wall from a user;
a visual representation of the wall based on received input wall parameters; and
an output result based on a determined STC and/or STL; and
a determination module implemented by the processor and memory for determining the STC and/or STL based on the wall parameters in response to a received confirmation of the visual representation;
wherein said determination module comprises:
a prediction model for predicting one or more sound transmission losses and/or sound transmission classes based on an input set of standardized model inputs; and
a preprocessor for processing the received input wall parameters to determine the set of standardized model inputs for the prediction model.

19. The system of claim 18, wherein the input wall parameters comprise one or more of:
a number of boards; and/or
one or more board parameters; and/or
one or more framing system parameters for a frame comprising at least one stud; and/or
an insulation material; and/or
a resilient channel material.

20. The system of claim 18, further comprising:
a wall parameter updater for updating initial or default wall parameters based on the received input wall parameters;
wherein the display generator comprises a visual representation generator for generating the visual representation of the wall based on the received input wall parameters, wherein the visual representation is interactive and/or editable by a user.

21. A method of generating, in real time, a sound transmission class (STC) for a wall using a processor and memory, the method comprising:
generating, on a user display, a graphical user interface (GUI) for selectively receiving a plurality of input wall parameters for the wall;
receiving the input wall parameters;
generating, on the user display, a visual representation of the wall based on the received input wall parameters;
receiving a confirmation of the visual representation;
in response to the confirmation, determining an STC based on the wall parameters; and
outputting a result based on the determined STC on the display;
wherein said determining the STC comprises:
preprocessing the wall parameters to determine a set of standardized model inputs for an STC prediction model,
inputting the determined set of standardized model inputs into the STC prediction model; and
determining the STC using the STC prediction model.

22. A method of generating, in real time, a sound transmission loss (STL) for a wall using a processor and memory, the method comprising:
generating, on a user display, a graphical user interface (GUI) for selectively receiving a plurality of input wall parameters for the wall;
receiving the input wall parameters;
generating, on the user display, a visual representation of the wall based on the received input wall parameters;
receiving a confirmation of the visual representation;
in response to the confirmation, determining one or more sound transmission loss (STL) values based on the wall parameters; and
outputting a result based on the determined one or more sound transmission loss (STL) values on the display;
wherein said determining the one or more sound transmission loss (STL) values comprises:
preprocessing the wall parameters to determine a set of standardized model inputs for an STL prediction model,
inputting the determined set of standardized model inputs into the STL prediction model; and
determining the one or more sound transmission loss (STL) values using the STL prediction model.
